(19) United States
(12) Patent Application Publication
(10) Pub. No.: US 2014/0101293 A1
(43) Pub. Date: Apr. 10, 2014

(54) APPARATUS AND METHOD FOR PROVIDING ISSUE RECORD, AND GENERATING ISSUE RECORD

(71) Applicant: Electronics and Telecommunications Research Institute, (US)

(72) Inventor: Hyo Jung OH, Daejeon (KR)

(73) Assignee: Electronics and Telecommunications Research Institute, Daejeon (KR)

(21) Appl. No.: 13/837,698

(22) Filed: Mar. 15, 2013

(30) Foreign Application Priority Data
Oct. 10, 2012 (KR) 10-2012-0112267

(51) Int. Cl. H04L 29/08

(52) U.S. Cl. CPC H04L 67/10
USPC 709/219

(57) ABSTRACT

Disclosed is a technology for extracting issue information having high interests to users by recognizing contents of a sentence within media (including news, Tweet, and a blog), and automatically detecting and presenting an issue subject related to the issue information. A method of providing issue information according to the present invention includes: extracting an issue by extracting issue information according to a predetermined condition or a condition received from the outside by using data expressed with a text on media or meta data defining additional information on the data; and displaying an issue history or hotness of the extracted issue information which has been issued in the media to a user.

### CROSS-REFERENCE TO RELATED APPLICATIONS

This application claims priority to and the benefit of Korean Patent Application No. 10-2012-0112267 filed in the Korean Intellectual Property Office on Oct. 10, 2012 the entire contents of which are incorporated herein by reference.

### TECHNICAL FIELD

The present invention relates to a technology for extracting issue information having high interests to users by recognizing contents of a sentence within the media (including news, Tweet, and a blog), and automatically detecting and presenting a subject of an issue related to the issue information.

### BACKGROUND ART

Demands for a technology for detecting an issue having high interests to users from the media explosively increasing everyday have been increased, but most services detect an issue word simply based on a frequency (for example, “Social Metrics” of Daum Soft, “Pulse” of Konan Technology). However, a frequency of appearance of a target keyword (mainly a word) is based on, so that a countermeasure for a case in which a frequency of appearance is regularly increased by a word always having a high frequency of appearance or a seasonal factor is insufficient. There is no consideration on a quality of a ripple effect or importance of an issue word disadvantageously.

An issue word is equally treated without consideration of a characteristic of the media (news/Tweet/blog), so that reliability of the media is not reflected.

### SUMMARY OF THE INVENTION

The present invention has been made in an effort to provide a method of recommending an issue having high interests to users for a predetermined term by complexly analyzing various factors, such as novelty, importance, a ripple effect, and a degree of concern of an issue candidate, while doing away with a method of recommending an issue and a relevant issue from the media only based on a frequency of a keyword.

The present invention has been also made in an effort to provide a method of recognizing reliability of an issue considering a characteristic of the social media and a method of suggesting a detected issue and a relevant issue to a user.

An exemplary embodiment of the present invention provides a user equipment, including: a user input unit configured to receive a keyword from a user; a communication unit configured to transmit the keyword to a server for providing an issue record representing an issue history or hotness of the keyword on media, and receive the issue record; a display unit configured to display the issue record to the user; and a control unit configured to control operations of the display unit, the user input unit, and the communication unit.

Another exemplary embodiment provides a server for providing an issue record, including: a reception unit configured to receive a keyword from a user equipment; an issue record generation unit configured to generate an issue record by recognizing an issue history or hotness of the keyword on media; a transmission unit configured to transmit the issue record to the user equipment; and a control unit configured to control operations of the reception unit, the issue record generation unit, and the transmission unit.

Yet another exemplary embodiment provides a method providing a user with an issue record, including: receiving a keyword from a user; transmitting the keyword to a server for providing an issue record representing an issue history or hotness of the keyword on media; receiving the generated issue record from the server; and displaying the issue record to the user.

Still another exemplary embodiment provides a method of generating an issue record, including: extracting issue keywords which have been issues on media by receiving a keyword from a user equipment or using data in the media or meta data of the data; generating the issue record by recognizing an issue history or hotness of the keyword; and transmitting the issue record to the user equipment.

According to exemplary embodiments of the present invention, it is possible to rank hotness obtained by analyzing various issue qualifications. The various qualifications (the five qualifications in the present invention are utilized), simply not a frequency, are complexly analyzed, thereby improving more accurate issue detection performance, and an issue property is analyzed by reflecting the characteristic of the media, thereby improving reliability of an issue. It is possible to prevent an error (snow in the winter, yellow dust in the spring, an advertisement of a specific entertainer, and the like) of recommending a word that is seasonally generated or simply focused as an issue.

The media collected in real time are automatically analyzed through automatic issue detection from which a manual operation is excluded, and an issue is detected, so that a user may more rapidly analyze a trend. While the existing technology selects an interested keyword of a user in advance, analyzes the media, and extracts a relevant issue, the suggested method determines an issue property for all target words appearing in the media, and ranks and manages the words, thereby enabling a user to input any keyword and being capable of presenting a result.

It is possible to analyze a trend and effectively handle the trend. It is possible to analyze public opinions through a result of issue detection in real time in the media, such as news, blogs, and Twitter, and recognize a detailed subject currently attracting interest through a result of recommendation of an issue related to a corresponding issue word. Accordingly, it is possible to rapidly prepare a future countermeasure through the analysis of the public opinions and the recognition of the detailed subject.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram illustrating a system for providing an issue record according to an exemplary embodiment of the present invention.

FIG. 2 is a block diagram illustrating a user equipment for performing a method of providing an issue record according to an exemplary embodiment of the present invention.

FIGS. 3A and 3B are diagrams exemplifying an issue record provided according to an exemplary embodiment of the present invention.

FIG. 4 is a block diagram illustrating a server for performing a method of generating an issue record according to an exemplary embodiment of the present invention.

FIG. 5 is a detailed flowchart illustrating an issue information extraction unit of FIG. 4.

FIG. 6 is a flowchart illustrating a method of providing an issue record according to an exemplary embodiment of the present invention.

FIG. 7 is a flowchart illustrating a method of generating an issue record according to an exemplary embodiment of the present invention.

FIG. 8 is a flowchart illustrating a step of extracting issue information according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Hereinafter, exemplary embodiments according to the present disclosure will be described in detail with reference to the accompanying drawings. In the following description, the same elements will be designated by the same reference numerals, so that a repeated description will be omitted. In the following description, a detailed explanation of known related functions and constitutions may be omitted so as to avoid unnecessarily obscuring the subject matter of the present disclosure.

The present invention will be described below with reference to the accompanying drawings. However, the present invention extends beyond the limited exemplary embodiments, so that those skilled in the art will easily appreciate well that the detailed description given in the present specification in relation to the drawings is illustrative.

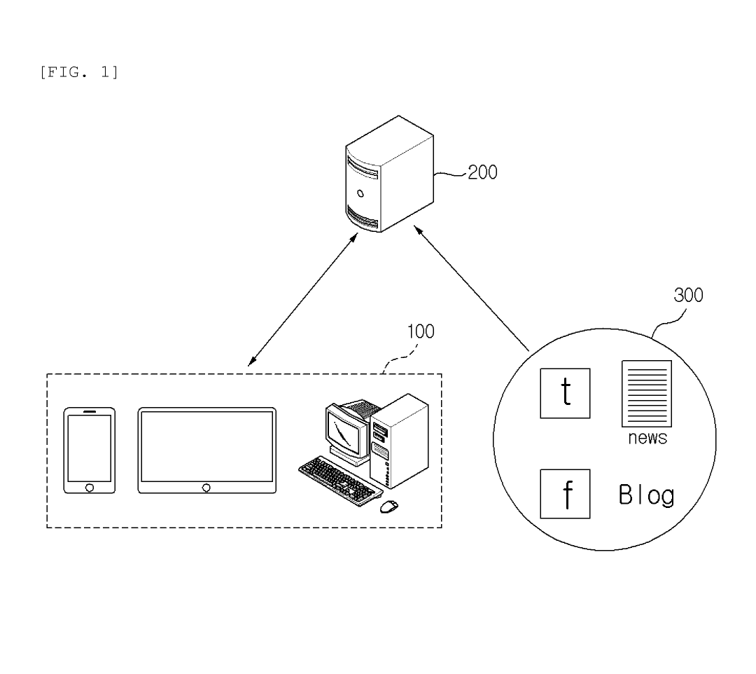

FIG. 1 is a block diagram illustrating a system for providing issue information to a user according to an exemplary embodiment of the present invention.

Referring to FIG. 1, a system for providing issue information in the present exemplary embodiment includes a user equipment 100, a server 200, and a social media 300. The system for providing the issue information is configured so that, when a user inputs a keyword through the user equipment 100, the server 200 searches for text/meta data related to the keyword from the social media 300 to extract an issue word, and provides the user with the extracted issue word through the user equipment 100.

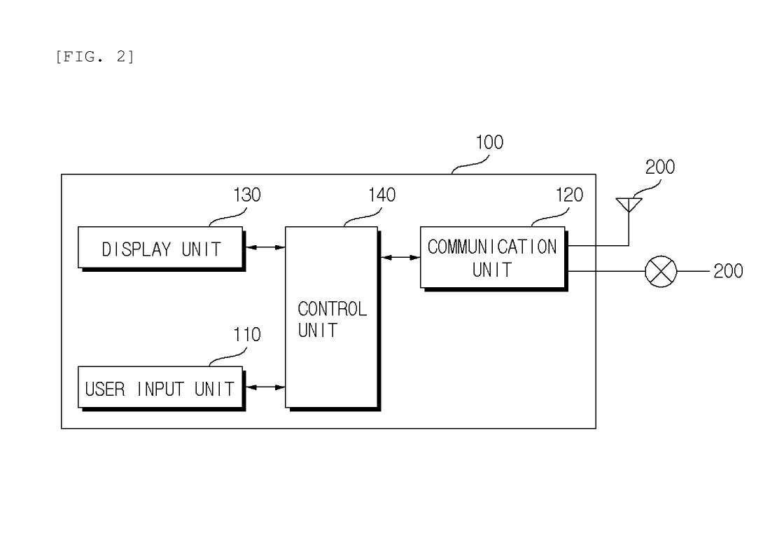

When the user does not input a keyword, the server 200 extracts issue words which have been current issues, and provides the user with the extracted issue words through the user equipment 100. Hereinafter, the user equipment of the system for providing the issue information according to the exemplary embodiment of the present invention will be described in more detail with reference to FIG. 2.

Referring to FIG. 2, the user equipment 100 in the present exemplary embodiment includes a user input unit 110, a communication unit 120, a display unit 130, and a control unit 140.

The user input unit 110 receives input of a keyword from the user. In the present exemplary embodiment, the user inputs the keyword for interested information in order to recognize a degree by which the interested information has been a current issue on the social web media.

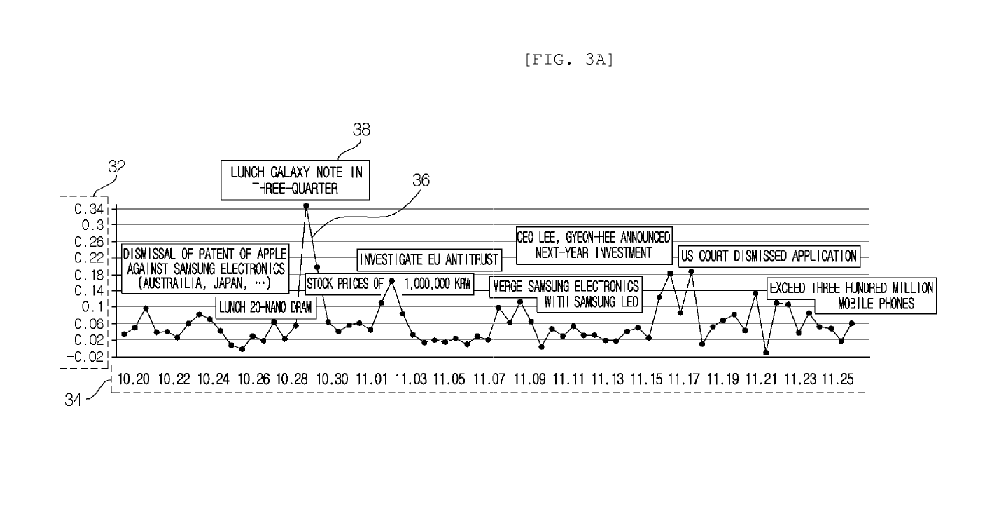

Referring to FIG. 3A, when the user is interested in an issue of patent litigation by Samsung Electronics against Apple, stocks of Samsung Electronics, a statue of the launch of a new product of Samsung Electronics, and inputs Samsung Electronics as a keyword, the user may obtain information on hotness and an issue history of Samsung Electronics on the social web media.

In the present exemplary embodiment, the social web media mean transmission media of all information existing on the online. The social web media are the concept including social media, that is, social network services, such as blogs, Twitters, and Facebook, as an online platform sharing personal thoughts, opinions, experiences, and information based on a recent social network, and a web-based platform, such as Wiki and UCC, as well as a portal site for providing information, such as news articles, as the web-based information transmission media.

The communication unit 120 transmits the keyword to the server for providing the issue record representing the issue history or the hotness of the keyword in the media, and receives the issue record. That is, the communication unit 120 transmits the keyword input by the use through a transmission unit to the server for providing the issue record, and receives the issue record from the server through a reception unit.

The display unit 130 displays the issue record received from the reception unit to the user. The display unit 130 may display the issue history of the issue record with the hotness for each date or in the unit of a specific term to the user.

In the present exemplary embodiment, the issue record is information containing the hotness and the issue history of the keyword on the social web media. Referring to FIG. 3, the issue record may be information represented by a graph 36 having a time 34 in the x-axis and a hotness 32 in the y-axis. The hotness means a degree of interest for the input keyword on the social web media, and the hotness will be described in more detail in an issue record providing server to be described below.

The issue history may be representation of a status of change in the issue for Samsung Electronics for each data when Samsung Electronics is input as a keyword. That is, the issue record may be an issue history represented through the hotness.

The display of the issue history for each date or in the unit of a term may be the display of the hotness for the input keyword for the specific term according to the date 34 as illustrated in FIG. 3A. In a case where the hotness is displayed for each date, when the hotness is represented highly, the user may guess that an event attractable interest in relation to the keyword is generated at a corresponding date, and guess contents of the event based on summary information to be described below.

The hotness may be displayed in the unit of a predetermined term, instead of each date. For example, in order to display the hotness of the keyword for one day, the hotness may be divided in the unit of a time to be displayed. Otherwise, in order to recognize the hotness of the keyword in terms of a big stream for a long term, such as one year, the hotness may be divided in the unit of a month to be displayed. Accordingly, the unit of the term may be a predetermined term set for user desired information based on a date as a basic value.

When the display unit 130 displays the issue history of the issue record to the user for each date or in the unit of the specific term, the display unit 130 may simultaneously display summary information 38 implying the issue information related to the keyword at the corresponding date or the specific term.

In the present exemplary embodiment, the issue information may mean data including the input keyword on the social web media. Accordingly, the summary information 38 implying the issue information is information implying the data. For example, when the data including the keyword is a news article, the issue information may be information implying contents of the news, such as a headline of the corresponding news.

The simultaneous display of the summary information 38 in the present exemplary embodiment may be the display of the hotness corresponding to each vertex with a label for the issue history represented as the graph of FIG. 3A. That is, when “Galaxy Note” is selected as the issue information, the display of the summary information may be the display of “Samsung Electronics, Galaxy Note, and Launch” with a label understandable and readable by the user to the user by extracting the issue words related to “Galaxy Note”. The user may guess the schematic contents of the data by recognizing the summary information 38 containing the keyword through the label displayed together with the hotness. Referring to FIG. 3A, the summary information is displayed with the label of “Launch Galaxy Note in Third Quarter”, so that the user may guess that the reason of the high hotness of Samsung Electronics is the launch of a new product. A chance of success may also be predicted according to the hotness.

When the user selects the label for more accurate information, a link address of a web-site having all the data may be displayed, or the web-site may be directly connected to display the entire data.

The display unit 130 actively recognizes a current issue on the social web media through the issue information extraction unit 230 of the server 200 for providing the issue information to be described below and provides information on the extracted issue.

In this case, the provided issue information may be information according to issue records or the hotness of actively recognized issue keywords. That is, the information according to the hotness of the issue keyword may be information provided by ranking the issue keywords according to the hotness in order to notify a hot issue of a corresponding date.

The control unit 140 controls the operations of the display unit 130, the user input unit 110, and the communication unit 120, and controls so that the keyword input through the user input unit 110 is transmitted to the communication unit 120 and then transmitted to the server 200, or the display unit 130 displays the issue record received by the communication unit 120 from the server 200. The control unit 140 may control the communication unit or the display unit 130 by interpreting an additional command of the user input through the user input unit 110.

Hereinafter, the server 200 for providing the issue record to the user equipment 100 according to the present exemplary embodiment will be described.

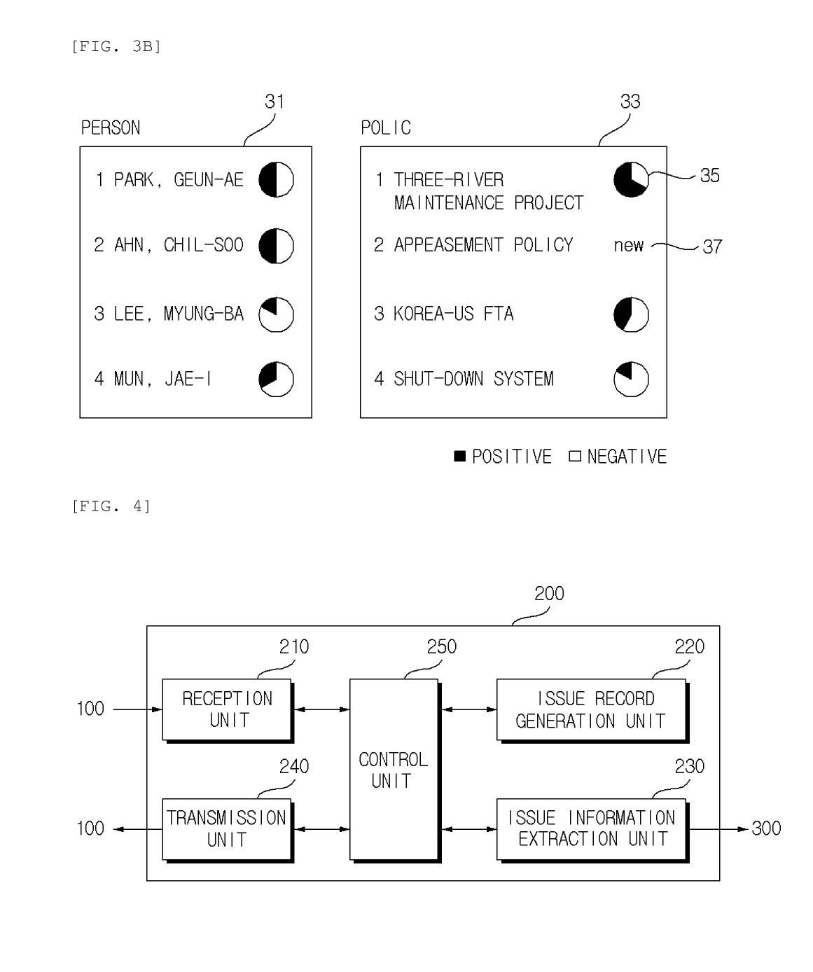

Referring to FIG. 4, the server for providing the issue record according to the present exemplary embodiment includes a reception unit 210, an issue record generation unit 220, an issue information extraction unit 230, a transmission unit 240, and a control unit 250.

The reception unit 210 receives the keyword from the user equipment 100. The reception unit 210 receives the keyword input by the user from the communication unit 120 of the user equipment.

The issue record generation unit 220 generates an issue record by recognizing an issue history or hotness of the keyword in the media. As described above, the issue history means a statue of change in interest of the input keyword on the social web media, and in this case, the interest on the social web media may be the hotness.

The hotness in the present exemplary embodiment may be measured by the N predetermined number of issue attributes for measuring the hotness of the keyword in the media.

In the present exemplary embodiment, the issue attribute may use information on an appearance history of a keyword in the media, information on a category defining an attribute of data including a keyword in the media, or information on a position defining a structural position of the keyword within the data.

The issue attribute may also use a degree of interest, such as the number of comments or the number of times of clippings of other users for the data including the keyword in the media.

In the present exemplary embodiment, the hotness may be measured through predetermined five issue attributes. A method of measuring the hotness will be described. In the present exemplary embodiment, novelty, importance, a ripple effect, a degree of reliability, and a degree of interest are used as the five issue attributes.

The novelty is an issue attribute meaning a degree by which a keyword newly appears within a given period, that is, a degree of novelty of the keyword.

The importance is an issue attribute for analyzing influence of the keyword to the web media, and means a degree of importance of the keyword. For example, in a case of news, the importance may be calculated by using position information according to whether a corresponding keyword frequently appears in a headline and according to the number of times of appearance of a corresponding keyword in a first paragraph, in terms of a structural position of the news.

The ripple effect is for measuring a ripple effect of a target keyword at a predetermined time point, and may be calculated by combining four detailed issue attributes below. The ripple effect may be calculated by variance defining advance-decline of a frequency of appearance, maintenance defining a maintenance period, stability representing the number of times/a term of appearance of a corresponding word, and the amount of accumulation representing the total number of times of appearance of the corresponding word.

The reliability is dependent on an attribute of the web media including data related to a keyword, and when the web media is Internet news, a word appearing in the news may be evaluated to have relatively high reliability, and a word frequently appearing in a personal blog, such as Twitter, may be evaluated to have low reliability.

The degree of interest is the attribute indirectly meaning a degree of interest of the user through the information, such as the number of comments or the number of clippings of other users for data in the media. The degree of interest may include an attribute for determining whether a tendency of the data in the media is a positive tendency or a negative tendency. For example, when a news article is a sarcastic article and includes a negative word, the degree of interest of a keyword included in the news may have a large absolute size, but may be represented by a negative (−) value, or when the news article includes a positive word, such as an appraising or recommending word, the degree of interest of a keyword may be represented by a positive (+) value.

For example, in a case of Twitter, since the degree of interest of users for a tweet much retwitted by users or the news having many comments is high, it is preferable to increase the hotness of the keyword appearing in a corresponding paper, so that the hotness may be measured by using the degree of interest as the issue attribute.

In the present exemplary embodiment, a combination method of Equation 1 may be used in order to assign the hotness through the five issue attributes. Here, issue information 1 means issue information represented at a predetermined specific term t, and w means respective keyword candidates w for issue information 1. dft(w) is a frequency of appearance as a basic issue attribute of the element w at the specific term t, αi is a weight for N issue attributes, and hi means a measured value for each issue attribute. Lt means a set of issues generated for the term t.

$$Hotness ( l , w , t ) = {\sum }_{w ∈ l} {\sum }_{i = 1}^{5} ( {a}_{i}^{*} {h}_{i} ) * d {f}_{t} ( w ) \\ d {f}_{i} ( w ) = d {f}_{t - 1} ( w ) + d {f}_{{L}_{i}} ( w ) \qquad [ Equation 1 ]$$

The equation is one example for describing the method of measuring the hotness by using the five issue attributes, and may be changed according to the number of types of used issue attributes and a characteristic of an issue attribute.

The issue record generation unit 220 according to the present exemplary embodiment generates the issue record representing the issue history of the keyword on the social web media by using the measured hotness.

The transmission unit 240 transmits the issue record generated in the issue record generation unit 220 to the user equipment 100.

The control unit 200 controls the operation of the reception unit 210, the issue record generation unit 220, the issue information extraction unit 230, and the transmission unit 240. The control unit 200 controls so that the issue record generation unit 220 generates the issue record for the keyword of the reception unit 210 or the issue keyword extracted through the issue information extraction unit 230, and the transmission unit 240 transmits the generated issue record to the user equipment 100.

Hereinafter, the issue information extraction unit 230 of the issue information providing server 200 will be described.

In addition to the provision of the issue record for the keyword input from the user by the server 200 for providing the issue record according to the present exemplary embodiment, in another exemplary embodiment, the server 200 for providing the issue record may extract information on an issue by actively recognizing a matter which has been a current issue on the social web media through the issue information extraction unit 230, and provide the issue record for the information on the issue.

In this case, referring to FIG. 3B in detail, the provision of the issue record may be implemented by extracting a plurality of issue keywords which has been issues on the social web media at a corresponding date and providing the issue record with information on a rank according to hotness and a classification (person 31, policy 33, product, company, and the like). When the information on the rank is provided, information on a new issue may be represented by a label 37 of “new”. Information on a positive or negative tendency of an issue keyword as information corresponding to the degree of interest among the issue attributes as additional information may be provided in a form of a pie chart 35.

That is, in the another exemplary embodiment, the issue information extraction unit 230 extracts issue information according to a predetermined condition or a condition input from the outside by using data expressed with a text of the social web media or meta data defining the additional information of the data.

The data expressed with the text among data existing in the media may include all data expressible with the text as data converted from video or audio data or data extractable from the video or audio data depending on a case, as well as the data existing in the form of the text in the media. The meta data includes not only classification information defining a field to which the data pertains as an attribute for the data, property information defining a character (for example, a positive character or a negative character) of the data, media information defining a type of media including the data, but also direct attribute information on the data, such as a writer of the data, a written date, and the number of times of search as data on the aforementioned data, that is, additional information on the data.

That is, the issue information extraction unit 230 extracts issue information according to a condition through the data and the meta data of the data. Here, the condition is predetermined or received from the outside, and the predetermined condition means the condition determined according to a predetermined algorithm or a condition set as a basic value.

For example, the predetermined condition may be a condition determined through an algorithm determining a preferred condition by using a history of input of the condition of the user. Here, when the condition is a hotness term of the issue information desired to be recognized by the user, a term averagely desired by the user may be determined by using information on a hotness term mainly input in the past.

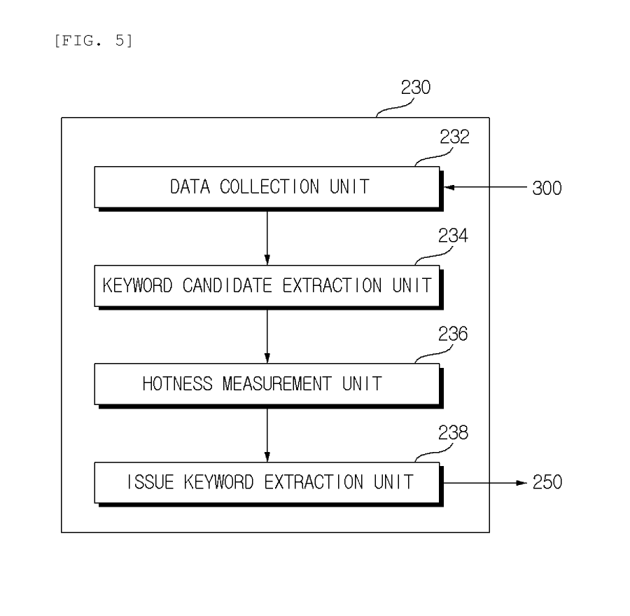

The issue information extraction unit 230 will be described in more detail with reference to FIG. 5.

The issue information extraction unit according to the present exemplary embodiment includes a data collection unit 232, a keyword candidate extraction unit 234, a hotness measurement unit 236, and an issue keyword extraction unit 238.

The data collection unit 232 collects data on the web media (including news, blogs, Twitter, and the like) 300 and stores the collected data. Accordingly, the server 200 for providing the issue record in the present exemplary embodiment may include a separate database for storing the collected data.

The keyword candidate extraction unit 234 extracts the collected data and meta data for the collected data, and then performs a language analysis process based on a language unit analysis, entity name recognition, relation extraction, and the like. The language unit analysis is for analyzing each sentence of text data by dividing the sentence into small units, and means an analysis of a text based on a minimum unit having a meaning. The entity name recognition recognizes meanings of the texts analyzed by each unit based on a result of the language unit analysis. A detailed method thereof is disclosed in Korean Patent Registration No. 10-0829401 (registered on May 7, 2008).

The keyword candidate extraction unit 234 extracts keywords capable of implying data by analyzing the media through an information extraction process based on machine learning based on the result of the language analysis and intellectualizing the analyzed media. That is, at least one keyword candidate is extracted as a candidate of an issue keyword for generating the issue record by using the data or the meta data.

The hotness measurement unit 236 measures hotness of the keyword candidate according to the predetermined algorithm, and measures hotness of the analyzed keyword candidate (a common noun and an entity name, an act noun derivable from a verb of “do”). The hotness measurement unit measures the hotness of the input keyword by the same method as that of the issue record generation unit, so that a detailed description will be omitted.

The issue keyword extraction unit 238 ranks the keyword candidates according to the measured hotness, and extracts the keywords having a predetermined rank or higher as the issue keyword. Then, the issue record generation unit 220 generates the issue record by using the issue keyword extracted from the issue information extraction unit, and the issue record providing server provides the user equipment 100 with the generated issue record by the same manner as that of providing the issue record according to the input keyword.

In order to notify the user of a kind of information which has been an issue in the media, such as a hot issue of that day, the issue record generation unit in the present exemplary embodiment may provide the plurality of issue keywords to the user equipment 100 by generating the plurality of issue keywords extracted by the issue keyword extraction unit 238 as ranking information according to the hotness.

Hereinafter, a process of generating and providing the issue record by the user equipment and the issue record providing server according to the present exemplary embodiment will be described with reference to the accompanying drawings.

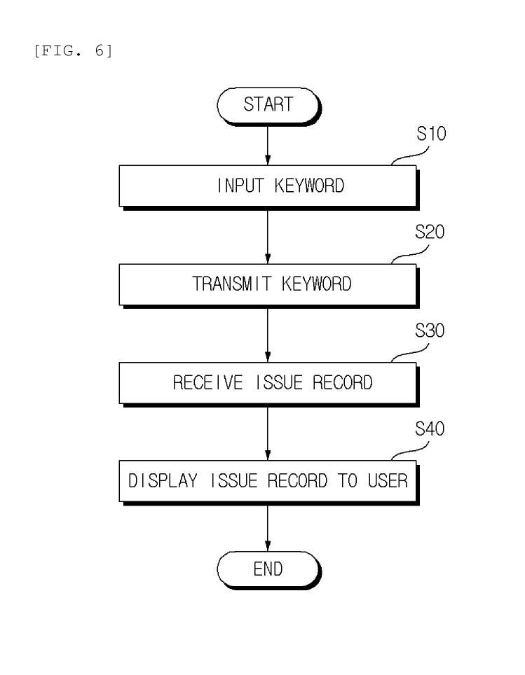

FIG. 6 is a flowchart illustrating a method of providing the issue record through the user equipment according to an exemplary embodiment of the present invention.

Referring to FIG. 6, the method of providing the issue record includes inputting a keyword (S10), transmitting the keyword (S20), receiving an issue record (S30), and displaying the issue record to a user (S40).

In the inputting of the keyword (S10), the user input unit 110 receives the keyword from the user.

In the transmitting of the keyword (S20), the communication unit transmits the keyword to the server for providing the issue record representing an issue history or hotness of the keyword in the media.

In the receiving of the issue record (S30), the communication unit receives the generated issue record from the server.

In the displaying of the received issue record to the user (S40), the display unit 130 displays the issue record received through the communication unit to the user.

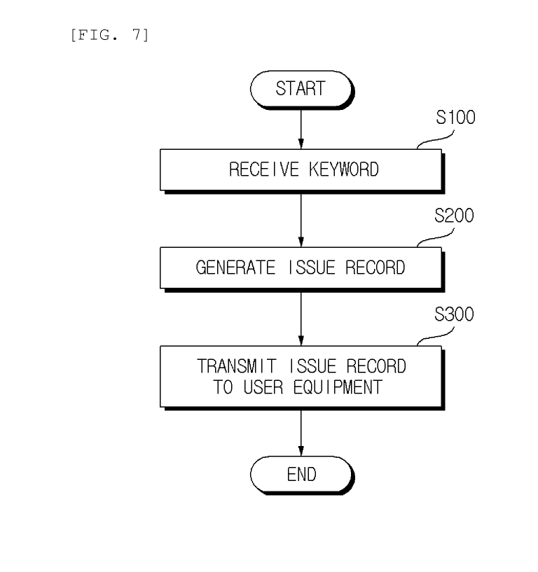

FIG. 7 is a flowchart illustrating a method of generating the issue record according to the exemplary embodiment of the present invention by the server for providing the issue record.

Referring to FIG. 7, the method of generating the issue record includes receiving a keyword (S100), generating an issue record (S200), and transmitting the generated issue record to the user equipment (S300).

In the receiving of the keyword (S100), the reception unit 210 receives the keyword from the user equipment 100. The reception unit 210 receives the keyword input by the user from the communication unit 120 of the user equipment.

In the generating of the issue record (S200), the issue record generation unit 220 generates the issue record by recognizing an issue history or hotness of the keyword in the media.

In the transmitting of the generated issue record to the user equipment (S300), the transmission unit 240 transmits the issue record generated by the issue record generation unit 220 to the user equipment 100.

In addition to the provision of the issue record for the keyword input from the user, the method of generating the issue record according to the present exemplary embodiment may extract issue information by actively recognizing a kind of a matter which has been a current issue on the social web media through extracting the issue information (S100′), and providing the issue record for the extracted issue information.

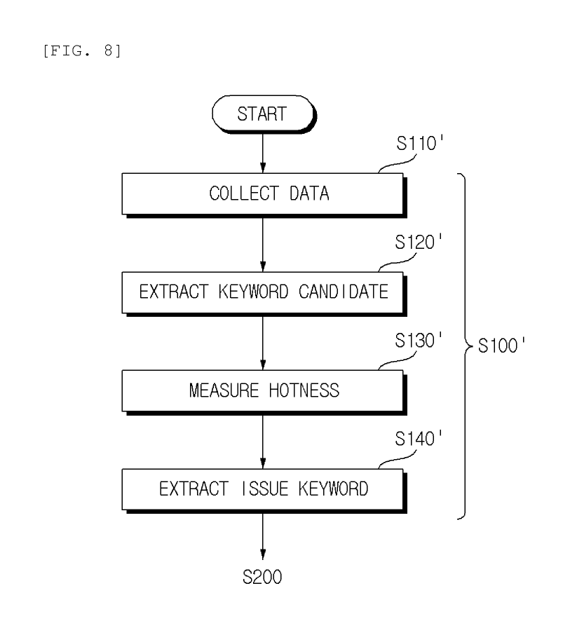

Referring to FIG. 8, the extracting of the issue information (S100′) includes collecting data (S110′), extracting a keyword candidate (S120′), measuring hotness (S130′), and extracting an issue keyword (S140′).

In the collecting of the data (S110′), the data collection unit 232 collects data on the web media (including news, blogs, Twitter, and the like) 300 and stores the collected data.

In the extracting of the keyword candidate (S120′), the keyword candidate extraction unit 234 extracts the collected data and meta data for the collected data, performs a language analysis process based on a language unit analysis, entity name recognition, and relation extraction, and analyzes the media through an information extraction process based on machine learning based on a result of the language analysis and intellectualized analyzed media to extract a keyword capable of implying the data.

In the measuring of the hotness (S130′), the hotness measurement unit 236 measures hotness of the keyword candidate according to a predetermined algorithm.

In the extracting of the issue keyword (S140′), the issue keyword extraction unit 238 ranks keyword candidates according to the measured hotness and extracts the keywords having a predetermined rank or higher as the issue keyword. Than, in the generating of the issue record, the issue record is generated by using the issue keyword extracted in the extracting of the issue information.

The respective steps correspond to the operations of the respective devices of the user equipment for providing the issue record and the operations of the respective devices of the server for providing the issue record, so that repeated detailed descriptions thereof will be omitted.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A user equipment, comprising:
a user input unit configured to receive a keyword from a user;
a communication unit configured to transmit the keyword to a server for providing an issue record representing an issue history or hotness of the keyword on media, and receive the issue record;
a display unit configured to display the issue record to the user; and
a control unit configured to control operations of the display unit, the user input unit, and the communication unit.

2. The user equipment of claim 1, wherein the display unit displays the issue history of the issue record with the hotness for each date or in the unit of a specific term.

3. The user equipment of claim 2, wherein when the display unit displays the issue history of the issue record for each date or in the unit of the specific term, the display unit displays summary information implying issue information related to the keyword at a corresponding date or a specific term to the user.

4. The user equipment of claim 1, wherein the server measures the hotness by using N predetermined issue attributes for measuring hotness of the keyword in the media.

5. The user equipment of claim 4, wherein the hotness is measured by using information on an appearance history of the keyword in the media as the issue attribute.

6. The user equipment of claim 4, wherein the hotness is measured by using importance of the keyword in the media including the keyword as the issue attribute.

7. The user equipment of claim 4, wherein the hotness is measured by using a degree of interest including a tendency for data in the media including the keyword or the number of comments or the number of times of clippings of other users as the issue attribute.

8. A server for providing an issue record, comprising:
a reception unit configured to receive a keyword from a user equipment;
an issue record generation unit configured to generate an issue record by recognizing an issue history or hotness of the keyword on media;
a transmission unit configured to transmit the issue record to the user equipment; and
a control unit configured to control operations of the reception unit, the issue record generation unit, and the transmission unit.

9. The server of claim 8, wherein the issue record generation unit measures the hotness by using N predetermined issue attributes for measuring hotness of the keyword in the media.

10. The server of claim 8, wherein the hotness is measured by using information on an appearance history of the keyword in the media as the issue attribute.

11. The server of claim 8, wherein the hotness is measured by using importance of the keyword in the media including the keyword as the issue attribute, or a degree of interest including a tendency for data in the media including the keyword or the number of comments or the number of times of clippings of other users as the issue attribute.

12. The server of claim 8, further comprising:
an issue information extraction unit configured to extract issue keywords which have been issues in the media by using data in the media or meta data of the data,
wherein the issue record generation unit generates the issue record by recognizing an issue history or hotness of the issue keyword.

13. The server of claim 12, wherein the issue record generation unit generates issue information according to hotness of the plurality of issue keywords.

14. A method providing a user with an issue record, comprising:
receiving a keyword from a user;
transmitting the keyword to a server for providing an issue record representing an issue history or hotness of the keyword on media;
receiving the generated issue record from the server; and
displaying the issue record to the user.

15. The method of claim 14, wherein the displaying of the issue record comprises displaying the issue history of the issue record with the hotness for each date or in the unit of a specific term.

16. The method of claim 15, wherein the displaying of the issue record comprises displaying summary information implying issue information related to the keyword at a corresponding date or a specific term to the user when displaying the issue history of the issue record for each date or in the unit of the specific term.

17. A method of generating an issue record, comprising:
extracting issue keywords which have been issues on media by receiving a keyword from a user equipment or using data in the media or meta data of the data;
generating the issue record by recognizing an issue history or hotness of the keyword; and
transmitting the issue record to the user equipment.

18. The method of claim 17, wherein the generating of the issue record measuring the hotness by using N predetermined issue attributes for measuring the hotness of the keyword in the media.

19. The method of claim 17, further comprising:
extracting issue keywords which have been issues in the media by using data in the media or meta data of the data,
wherein the generating of the issue record comprises generating the issue record by recognizing an issue history or hotness of the issue keyword.

20. The method of claim 19, wherein the generating of the issue record comprises generating issue information according to hotness of the plurality of issue keywords.
